(19) United States
(12) Patent Application Publication
(10) Pub. No.: US 2020/0132866 A1
(43) Pub. Date: Apr. 30, 2020

(54) X RAY-TO-INFRARED CONVERSION STRUCTURES FOR ILLUMINATING X RAY DETECTORS WITH INFRARED LIGHT TO IMPROVE PERFORMANCE

(71) Applicant: REDLEN TECHNOLOGIES, INC., Saanichton (CA)

(72) Inventors: Saeid Taherion, Victoria (CA); Georgios Prekas, Victoria (CA)

(21) Appl. No.: 16/659,096

(22) Filed: Oct. 21, 2019

Related U.S. Application Data
(60) Provisional application No. 62/750,335, filed on Oct. 25, 2018.

(51) Int. Cl. G01T 1/202; G02B 5/20; G02B 5/26; G01T 1/20

(52) U.S. Cl. CPC G01T 1/2023; G01T 1/2002; G02B 5/26; G02B 5/208

(57) ABSTRACT

Various embodiments include a structure that is configured to emit infrared (IR) light when exposed to ionizing radiation, such as X ray and gamma radiation, and to be positioned adjacent to a radiation detector so that infrared light illuminates the radiation detector when the structure and detector are exposed to the ionizing radiation. The structure may include a layer that is opaque to ultraviolet (UV) and visible light, another layer that is opaque to UV and visible light, and an intermediate layer that is configured to emit IR light when exposed to ionizing radiation. The intermediate layer may be a single layer. The intermediate layer may be two layers including a layer configured to emit UV or visible light when exposed to ionizing radiation and a layer configured to emit IR light when exposed to UV or visible light.

### FIELD

The present application relates generally to radiation detectors for computed tomography imaging systems, and more specifically to radiation detectors including a structure that converts X rays into infrared light.

### BACKGROUND

In computed tomography (CT) imaging systems, an X ray source emits a fan-shaped beam toward an object, which may be, for example, a piece of baggage at an airport scanner or a patient in a medical diagnostic clinic, or any other biological or non-biological object under imaging. The X ray beam is attenuated by the object, and is subsequently detected by a detector array, such as a cadmium zinc telluride (CdZnTe) detector. Other direct conversion detectors employing cadmium telluride (CdTe), gallium arsenide (GaAs), or silicon (Si), or any indirect director based on a scintillator material, may also be used in CT imaging systems. Image slices collected by scanning the object can, when joined together, reconstruct 3-dimensional cross-section images of the object.

In typical CT imaging systems, an array of radiation detectors includes a number of solid-state detector elements (which may be arranged as pixels for imaging) that each produce a dedicated electrical signal indicating an amount of radiation reaching the detector element. The electrical signals may be transmitted to a data processing card for analysis. Finally, using image reconstruction techniques, a reconstruction image may be produced. The intensity of the attenuated beam received by each detector element depends upon the attenuation of the X ray beam by the object. For example, when scanning a human body, bone turns up white, air turns up black, and tissues and mucous turn up in shades of gray.

The electrical signal generated by radiation detectors, such as CdZnTe detectors, results from X rays exciting electrons in the atoms of the material that ejects electrons from their orbits and into a conduction band of the bulk material. Each electron ejected into the conduction band leaves behind a net positive charge that behaves like a positively charged particle known as a “hole” that migrates through the material in response to an electric field applied between a cathode and an anode. Electrons in the conduction band are attracted by the resulting internal electric field and migrate to the anode where they are collected creating a small current that is detected by circuitry, while the holes migrate towards the cathode.

Each X ray or gamma-ray will generate many electron-hole pairs, depending upon the energy of the photon. For example, the ionization energy of CdZnTe is 4.64 eV, so absorbing the energy of a 140 keV gamma ray from Technetium will generate about 30,000 electron-hole pairs.

A semiconductor radiation detector may include defects (e.g., dopants, vacancies, lattice defects, etc.) located in the band gap that can trap charge carriers (e.g., holes and/or electrons). Referred to as deep level defects, trapping charge carriers can affect the internal electric field that may cause dynamic effects and/or reduce the efficiency of the detector.

Additionally, holes in a semiconductor exhibit an effective mass depending upon which electron was ejected to create the hole. Holes with higher effective mass drift slower towards the cathode that lighter holes and electrons move faster than holes towards the anode. Also, as a result of such kinetics, when a radiation detector is subject to a high X ray flux, a large number of holes moving slower through the detector material than electrons can form a positive space charge in the detector. This positive space charge may reduce the internal electrical field in the detector, which may degrade performance of the detector.

### SUMMARY

Various embodiments of the present disclosure take advantage of the properties of certain materials or combination or layers of different material, to convert X rays into IR light of a range of wavelengths without the need of external light generator, filters or LEDs, to illuminate a solid-state X ray detector. The conversion of X rays into IR light can be done in one step (i.e., directly from X rays to IR) or in two (i.e., generation of ultraviolet (UV) or visible light from interactions with X rays followed by conversion of UV or visible light to IR light). A structure according to some embodiments may include a first layer that blocks UV and visible light, a second layer that interacts with X rays to generate UV or visible light, a third layer that converts UV or visible light into IR light, and a fourth layer that blocks UV or visible light but is transparent to IR light. IR light from this structure passing through the X ray detector material may interact with deep level defects that have long de-trapping times, neutralizing such defects so that interference with the internal electric field do not build up during exposure to an X ray flux. As a result, the dynamic response of the X ray detector may be enhanced.

### BRIEF DESCRIPTION OF THE DRAWINGS

The accompanying drawings are presented to aid in the description of embodiments of the disclosure and are provided solely for illustration of the embodiments and not limitation thereof.

FIG. 1 is a block diagram of an X ray imaging system suitable for use with various embodiments of the present disclosure.

FIG. 2 is a conceptual diagram of a semiconductor radiation detector illustrating X ray interactions generating electron-hole pairs.

FIG. 3 is a conceptual diagram of a semiconductor radiation detector illustrating how a high X ray flux can cause a space charge to develop within the detector materials.

FIG. 4 a block diagram of an X ray imaging system implementing various embodiments.

FIGS. 5A and 5B are diagrams of alternative configurations of an X ray-to-IR converter structure according to embodiments of the present disclosure.

FIG. 6 is a conceptual diagram of an X ray-to-IR converter structure illustrating various photon-material interactions.

FIG. 7 is a conceptual diagram of a semiconductor radiation detector illustrating how illumination of the radiation detector can result in improved performance of the detector.

FIG. 8 is a graph illustrating output counts of a semiconductor radiation detector with and without IR illumination.

FIG. 9 is a process flow diagram illustrating a method of improving the performance of an X ray imaging system according to embodiments of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims. Any reference to claim elements in the singular, for example, using the articles “a,” “an,” or “the” is not to be construed as limiting the element to the singular. The terms “example,” “exemplary,” or any term of the like are used herein to mean serving as an example, instance, or illustration. Any implementation described herein as an “example” is not necessarily to be construed as preferred or advantageous over another implementation. The drawings are not drawn to scale. Multiple instances of an element may be duplicated where a single instance of the element is illustrated, unless absence of duplication of elements is expressly described or clearly indicated otherwise.

Various embodiments of the present disclosure include a structure configured to convert some ionizing radiation into infrared (IR) radiation. The structure may be positioned within an imaging system, such as a computed tomography (CT) imaging system, so as to illuminate a radiation detector array with IR light, thereby improving the efficiency of the detector array. Various embodiments improve the dynamic response of CdZnTe radiation detectors/sensors under intense and rapidly changing X ray irradiation environments, such as in a medical Photon Counting CT scanner. Various embodiments may also be implemented in other applications where conditions of rapidly changing (microsecond range), variable intensity and X ray energy is expected, such as baggage scanners and non-destructive testing.

The structure may be used with any form of ionizing radiation, but is particularly useful for imaging systems having a high flux, such as a medical X ray CT imaging system or a gamma ray luggage scanning system. For ease of reference, the structure is referred to herein as an X ray-to-IR converter and reference is often made to X rays as the type of ionizing radiation. However, this short hand reference is not intended to limit the claims to just X ray applications unless specifically recited in the claims.

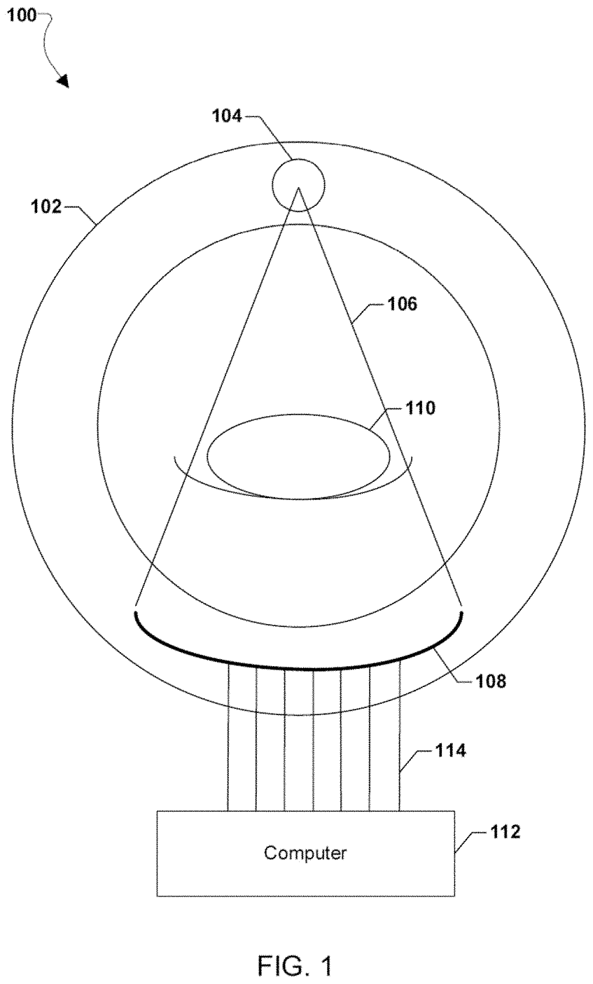

FIG. 1 is a functional block diagram of a CT imaging system 100 suitable for use implementing various embodiment methods. The CT imaging system 100 may include a gantry 102, which may include a moving part, such as a circular, rotating frame with an X ray source 104 mounted on one side and a curved detector array 108 mounted on the other side. The gantry 102 may also include a stationary (i.e., non-moving) part, such as a support, legs, mounting frame, etc., which rests on the floor and supports the moving part. The X ray source 104 may emit a fan-shaped X ray beam 106 as the gantry 102 and the X ray source 104 rotates around an object 110 inside the CT imaging system 100. The object 110 may be any biological (e.g., human patient) or non-biological (e.g., luggage) sample to be scanned. After the X ray beam 106 is attenuated by the object 110, the X ray beam 106 is received by the detector array 108. The curved shape of the detector array 108 allows the CT imaging system 100 to create a 360° continuous circular ring of the image of the object 110 by rotating the gantry 102 around the object 110.

For each complete rotation of the gantry 102, one cross-sectional slice of the object 110 is acquired. As the gantry 102 continues to rotate, the detector array 108 takes numerous snapshots called “view”. Typically, about 1,000 profiles are taken in one rotation of the gantry 102. The object 110 may slowly pass through the rotating gantry 102 so that the detector array 108 captures incremental cross-sectional profiles of the entire object 110. Alternatively, the object 110 may remain stationary and the gantry 102 is moved along the length of the object 110 as the gantry 102 is rotated. The data generated by the detector array 108 is passed to a computer 112 that may be located remotely from the gantry 102 via a connection 114. The connection 114 may be any type of wired or wireless connection. If the connection 114 is a wired connection, the connection 114 can include a slip ring electrical connection between the rotating part of the gantry 102 supporting the detector 108 and a stationary support part of the gantry 102 which supports the rotating part (e.g., the rotating ring). If the connection 114 is a wireless connection, the detector 108 mounted on the rotating part of the gantry 102 may contain any suitable wireless transceiver to communicate data with another wireless transceiver that is not located on the rotating part of the gantry 102 and which is in communication with the computer 112. The computer 112 may include processing and imaging applications that analyze each profile obtained by the detector array 108, and the full set of profiles from each rotation is compiled to form a two-dimensional image of a cross-sectional slice of the object 110.

Various alternatives to the design of the CT imaging system 100 of FIG. 1 may be employed to practice embodiments of the present disclosure. CT imaging systems may be designed in various architectures and configurations. For example, a CT imaging system may have a helical architecture. In a helical CT imaging scanner, the X ray source and detector array are attached to a freely rotating gantry. During a scan, a table moves the object smoothly through the scanner creating helical path traced out by the X ray beam. Slip rings enable the transfer of power and data on and off the rotating gantry. A switched mode power supply may be used to power the X ray source while at the same time still be small enough to be installed on the gantry.

In other embodiments, the CT imaging system may be a tomosynthesis CT imaging system. In a tomosynthesis CT scanner, the gantry may move in a limited rotation angle (e.g., between 15 degrees and 60 degrees) in order to detect a cross-sectional slice of the object. The tomosynthesis CT scanner may be able to acquire slices at different depths and with different thicknesses that may be constructed via image processing.

The detector array of a CT imaging system may include an array of radiation detector elements, such as pixel sensors. The signals from the pixel sensors may be processed by a pixel detector circuit, which may sort detected photons into energy bins based on the energy of each photon or the voltage generated by the received photon. When a photon is detected, its energy is determined and the photon count for its associated energy bin is incremented. For example, if the detected energy of a photon is 24 kilo-electron-volts (keV), the photon count for the energy bin of 20-40 keV may be incremented. The number of energy bins may range from one to several, such as two to six. In an illustrative example, a photon counting detector may have four energy bins: a first bin for detecting photons having an energy between 20 keV and 40 keV, a second bin for detecting photons having an energy between 40 keV and 60 keV, a third bin for detecting photons having an energy between 60 keV and 80 keV, and a fourth bin for detecting photons having an energy above 80 keV. The greater the total number of energy bins, the better the material discrimination.

In CT imaging systems, a scanned object is exposed to an X ray beam and attenuated photons from the X ray beam are detected and counted by individual radiation detectors (sometimes referred to as pixels) in a detector array. When an object is loaded in a CT imaging system, the X ray beam may be heavily attenuated, and the number of photons detected by the detector array may be orders of magnitude less than the number of photons emitted from an X ray source. For image reconstruction purposes, the detector array can be exposed to a direct X ray beam without an intervening object located inside the CT imaging system. In such cases, the photon count rates in the CT imaging system may reach values of 100 million counts per second per square millimeter (Mcps/mm²) or more. The detector array may be capable of detecting such a wide range of photon count rates.

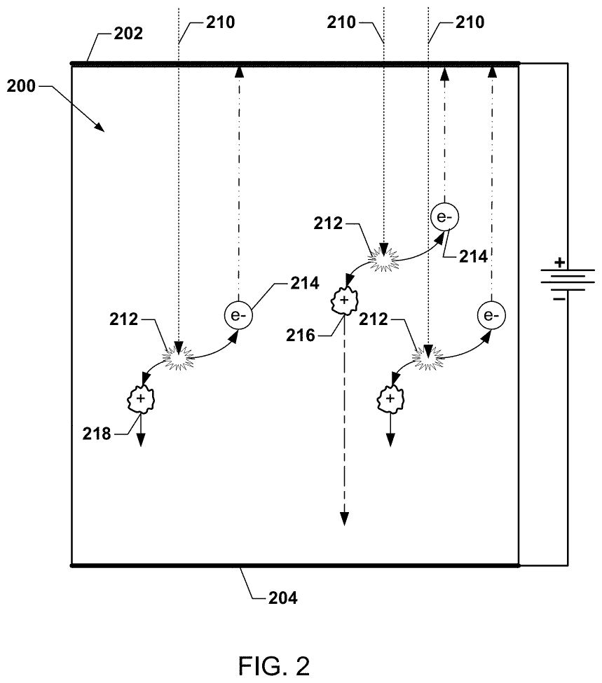

Referring to FIG. 2, among the interactions of an X ray 210 or gamma ray with the materials in a radiation detector 200 (e.g., CdZnTe detector material), the photo-electric effect results in complete absorption of the photon energy 212 and the generation of an electron cloud 214 and a corresponding cloud of holes 218 based on the energy of the absorbed photon. The generated electron-hole pairs separate under influence of the electric field applied to the detector 200 between an anode 202 and a cathode 204. The generated electrons 214 drift toward the anode 202, and the generated holes drift towards the cathode 204. The collection of electrons 214 at the anode 202 of the detector results in a current that is proportional to the energy of the absorbed photon 210, thereby enabling both detection of the photon and estimation of the photon's energy. Hole 218 mobility in CdZnTe is very low compared to electrons.

A space charge may develop inside the CdZnTe radiation detector during irradiation due to the formation of positively or negatively stationary charged traps. Depending on the nature of the traps or the impurities and their relative position with respect to the Fermi level in the band gap and their energy, a positive or negative space charge can be formed. This space charge can remain stationary if the conditions that caused the space charge to form do not change.

In applications in which the X ray intensity changes rapidly, such as in medical CT imagers or luggage scanners, formation of a space charge formation due to trapped charge carriers from the injection of holes, changes with time, and the amount of the space charge varies with time. This can result in dynamic changes in the internal electric field and eventually in the sensor response, mainly affecting the spectral and counting output of the sensor. This can make the spectral and counting output of the sensor time dependent.

A space charge may be formed when operating the radiation detector during biasing (i.e. while emptying of deep traps) by applying a voltage between the anode 202 and cathode 204. Depending on the radiation detector (e.g., CdZnTe material type and contact material), biasing can result in a net negative or net positive space charge forming within the detector material. By creating different domains of electrostatic potential between the anode and the cathode this space charge can dictate the uniformity and /or shape of the internal electric field. Typically, when uniform trapping and space charge formation is assumed between the sensor terminals, a negative space charge will create a linearly changing internal electric field that is higher at the cathode, whereas a positive space charge will create a linearly changing internal electric field that is higher at the anode. This non-uniform internal electric field will influence the transport of electrons, their induction rate at the anode and eventually their signal amplitude of counting pulses.

A space charge may also form when the radiation detector material is irradiated with a high flux of X ray photons resulting in a large number of electron-hole pairs. The injection of such a significant number of electrons and holes causes disturbance of the radiation detector initial steady stage. In CdZnTe the fast-moving electrons are swept away by the electric field, but the slow-moving holes have higher probability of being trapped. Many impurities (intrinsic or external) can act as trapping sites for holes. Depending on the density of these traps and their characteristics (e.g., life time, energy, cross section and density) and the different X ray intensities and energies, different numbers of injected electrons and holes will cause different amounts of internal electric field disturbances.

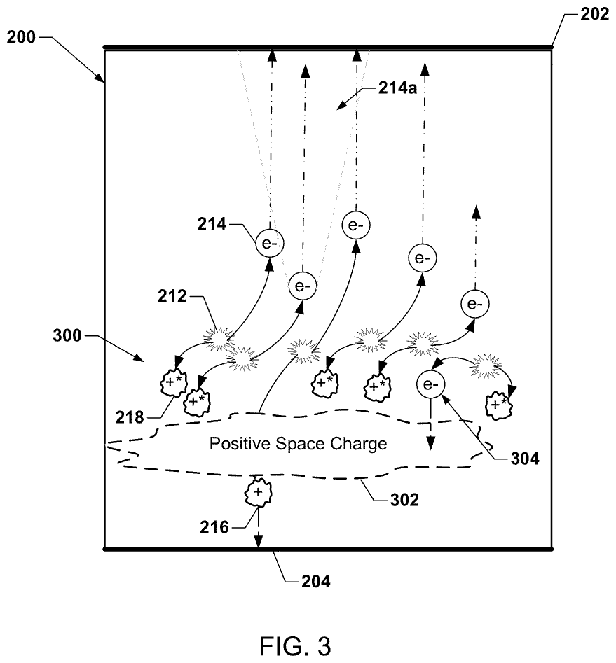

FIG. 3 illustrates these effects and the generation of a space charge within a radiation detector, such as a CdZnTe radiation detector array. When such a detector is irradiated by relatively high ionizing radiation flux, the formation of a positive space charge 302 may be mainly created by two causes. First, a positive space charge may be created due to ionization of long lifetime deep level hole traps 218 as described above. Second, a positive space charge may be created due to low or reduced mobility of holes 216 that are outside of a hole trap or captured by a trap. Under irradiation of a relatively high flux of ionizing photons, many electrons and hole clouds are formed in the detector by the many X ray-electron interactions. Due to deep traps and the low mobility of the hole clouds compared to electrons, a positive field charge 302 develops as the holes accumulate in the detector bulk while most electrons 214 are collected by the anode 202. The large positive space charge 302 in the detector reduces the internal electrical field in the detector, impacting the efficiency and responsiveness of the radiation detector. If the internal field is strong enough, some electrons (e.g., 304) may drift toward the space charge rather than the anode 204, thereby degrading detector performance and accuracy.

In addition to the effect of deep traps, holes generated by interaction of X rays with detector materials may have different effective masses and thus exhibit different levels of mobility through the detector. As used herein, the effective mass of a hole may be understood as the mass of that the hole appears to have when responding to internal electric fields, or the mass that the whole appears to have when grouped with other holes.

It is known that shining IR radiation on CdZnTe radiation detectors can improve detector efficiency. IR photons passing through a CdZnTe radiation detection crystal will interact with the deep level defects that have long de-trapping times. This interaction will cause at least some of these defects to be neutralized and consequently the effect on the internal electric field from deep level defects will be reduced or minimized. As a result, the dynamic response of the CdZnTe radiation detector will be enhanced. In addition to neutralizing deep traps, infrared radiation can excite electrons from lower-level bands to higher-level bands which is equivalent to transitioning holes with high effective mass into holes with lower effective mass, thereby enabling holes to move faster toward the cathode. This also helps to reduce space charges and enhance detector performance.

Various embodiments provide a structure of materials that convert a fraction of X ray radiation into infrared light that is configured to be positioned adjacent to radiation detectors within an X ray imaging system so that the detectors are exposed to infrared light whenever the detector is exposed to X rays. Various embodiments can improve the performance of the radiation detectors by exposing the detectors to infrared light for purposes freeing holes from deep level traps and/or transitioning holes with high effective mass into holes with lower effective mass without the need for external sources of infrared light or light guides for directing such light onto the detectors. Various embodiments thus provide an advantage of improving performance of X ray imaging systems while simplifying the configuration of the detectors for such systems.

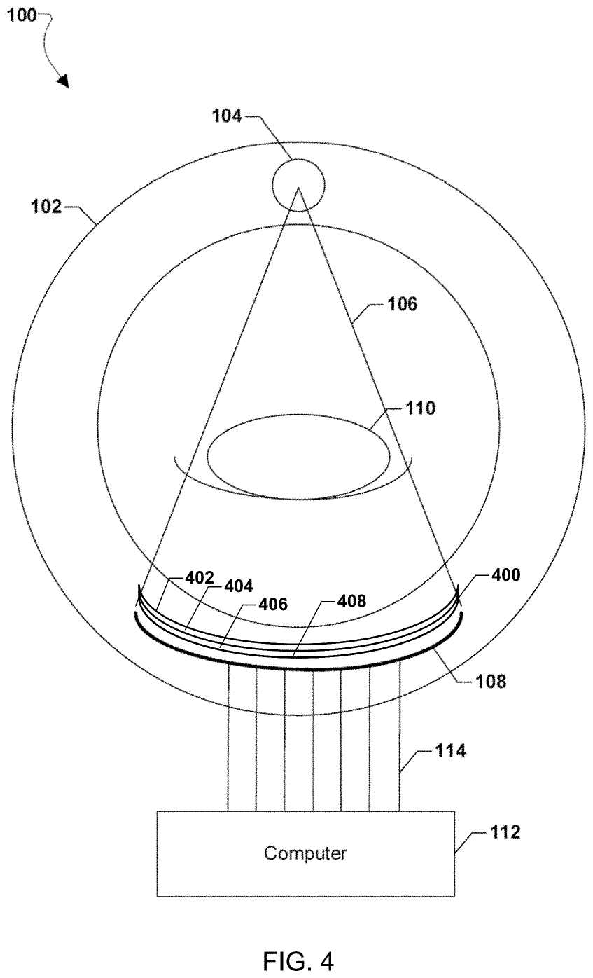

Referring to FIG. 4, various embodiments include an X ray to IR converter structure 400 positioned adjacent to the detector array 108 so that X rays 106 pass through the structure 400 before striking the detector array. As described in more detail below, the X ray to IR converter structure 400 may include a number of layers of materials 402, 404, 406, 408 that interact to emit IR radiation towards the detector array 108. Positioning the X ray to IR converter structure 400 adjacent to the detector array 108 enables infrared light leaving the structure to illuminate the detectors within the detector array 108. The spectrum of the generated IR may range from 840 nm up to 1500 nm, which are wavelengths IR radiation to which CdZnTe trap levels are sensitive, thereby provide the benefit of reducing the tendency of such traps to trap electrons or holes and build up a space charge.

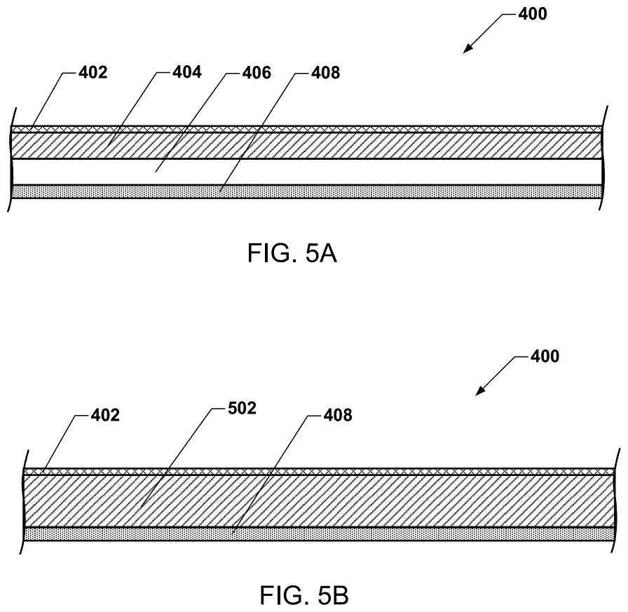

Referring to FIG. 5A, in various embodiments the X ray to IR converter structure 400 may include a first layer 402 of material selected to block visible light within the CT scanner 100 while permitting X rays to pass through. As an example, the first layer 402 may be a thin film of (e.g., 1 mm or less) aluminum, aluminum alloy or other metal. However, any opaque material with a small atomic number Z may be used in the first layer 402. In some embodiments, the first layer 402 material may be, or an interior surface of the first layer 402 may be coated or otherwise configured to be, reflective to light and IR radiation so that more UV and visible light is reflected towards the third layer.

In some embodiments, the X ray to IR converter structure 400 may include a second layer 404 of material that emits ultraviolet or visible light upon absorption of scattering of an X ray photon. Any number or combination of scintillation materials may be used in the second layer 404, including but not limited to: organic scintillators, such as anthracene (C₁₄H₁₀), stilbene (C₁₄H₁₂), and naphthalene (C₁₀H₈); liquid organic scintillators, such as p-terphenyl (C₁₈H₁₄), 2-phenyl-5-(4-phenylphenyl)-1,3,4-oxadiazole (PBD, C₂₀H₁₄N₂O), butyl PBD (C₂₄H₂₂N₂O), 2,5-diphenyl-1,3-oxazole (PPO, C₁₅H₁₁NO), and wavelength shifters such as POPOP (C₂₄H₁₆N₂O) (POPOP, C₂₄H₁₆N₂O) dissolved in toluene, xylene, benzene, phenylcyclohexane, triethylbenzene, or decalin; plastic scintillators, such as polyethylene naphthalate (C₁₄H₁₀O₄)ₙ); luminophors, such as polyphenyl hydrocarbons, oxazole and oxadiazole aryls, especially, n-terphenyl (PPP), 2,5-diphenyloxazole (PPO), 1,4-di-(5-phenyl-2-oxazolyl)-benzene (POPOP), 2-phenyl-5-(4-biphenylyl)-1,3,4-oxadiazole (PBD), and 2-(4′-tert-butylphenyl)-5-(4″-biphenylyl)-1,3,4-oxadiazole (B-PBD); inorganic crystals, such as Gd₂O₂S:Tb, thallium-doped sodium iodide (NaI(Tl)), CsI(Tl), CsI(Na), CsI(pure), CsF, KI(Tl), LiI(Eu), CsI(Tl), CsI(Na), CsI(pure), CsF, KI(Tl), LiI(Eu). Some non-alkali crystals include: BaF₂, CaF₂(Eu), ZnS(Ag), CaWO₄, CdWO₄, YAG(Ce) (Y₃Al₅O₁₂(Ce)), GSO (Gd₂SiO₅(Ce)), LSO (Lu₂SiO₅(Ce)), LaCl₃(Ce), lanthanum chloride doped with cerium, cerium-doped lanthanum bromide (LaBr₃(Ce)), and LYSO (Lu_{1.8}Y_{0.2}SiO₅(Ce)); and glass scintillators, such as cerium-activated lithium or boron silicates. As an example, the second layer 404 may be a Gd₂O₂S:Tb crystal. Light emitted due to scintillation interactions with X rays passes from the second layer 404 into the third layer 406.

In some embodiments, the X ray to IR converter structure 400 may include a third layer 406 of material that emits IR light or radiation upon absorption of an ultraviolet or visible light photon. Any number or combination of IR fluorescing materials may be used in the third layer 406, including but not limited to neodymium-doped glasses, ytterbium-doped glasses, holmium-doped glasses, thulium-doped glasses, erbium-doped glasses and spectral conversion materials such as Ca₁₄Zn₆Al₁₀O₃₅: Mn⁴⁺, Nd³⁺/Yb³⁺. As an example, the third layer 406 may be neodymium doped yttrium aluminum garnet (Nd:YAG). IR radiation generated in the third layer 406 passes through the fourth layer 408. As noted above, the first layer 402 may be of a material or include an interior coating that reflects IR radiation so that IR photons emitted in the third layer 406 towards the first layer are reflected towards the detector array 108.

In some embodiments, the X ray to IR converter structure 400 may include a fourth layer 408 of material that is transparent to IR light or radiation but absorbs ultraviolet or visible light. Any number or combination of materials that are translucent to IR light but opaque to UV and visible light may be used in the fourth layer 408. As an example, the fourth layer 408 may be a CdZnTe crystal, sapphire or any another material that will absorb or reflect photons with energies higher than the band gap energy of the crystal.

In some embodiments, the fourth layer 408 may be of a material or coated with a material that reflects UV and/or visible light so that such photons can pass back through the third layer 406 to increase the probability of absorption there and thus increase the generation of IR photons. In embodiments in which the first layer 402 and the fourth layer 408 are both configured to reflect internal UV and/or visible light, such photons may continue to be reflected internally until finally absorbed in the third layer 406, thereby further increasing the probability of absorption there and thus increase the generation of IR photons. The second and third layers are located between the first and fourth layers, and the second layer is located between the first and third layers, while the third layer is located between the second and fourth layers.

As illustrated in FIG. 5B, some embodiments may only have three layers, including the first layer 402 and the fourth layer 408 configured to block or reflect visible light, and an intermediate layer 502 that is configured to emit IR photons upon absorbing and/or scattering X ray photons. In such embodiments, the first layer 402 and the fourth layer 408 may be similar to or the same as the same numbered layers described above with reference to FIG. 5A. In some embodiments, the intermediate layer 502 may a material that directly emits IR photons in response to absorbing and/or scattering X ray photons. In some embodiments, the intermediate layer 502 may a mixture of materials that interact together to emit IR photons in response to absorbing and/or scattering X ray photons. For example, the intermediate layer 502 may include a first molecule or element that has a significant cross section for absorption or scattering of X rays that creates an exited state and a second molecule or element that has a significant cross section for absorbing energy from the exited state of the first molecule/element and emitting an IR photon. In some embodiments such mixtures of molecules/elements maybe in a crystalline structure to facilitate the transfer of energy to the IR emitting molecules/elements without the generation of UV or visible light photons. In some embodiments such mixtures of molecules/elements maybe in a solution or glass formulation and the transfer of energy from the first (i.e., X ray absorbing/scattering) molecules/elements to the second (i.e., IR emitting) molecules/elements may be via visible or UV photons. In such embodiments, the intermediate layer 502 may include the same or similar materials as the second and third layers 404, 406 as described above with reference to FIG. 5A except that the materials are mixed together into a single layer.

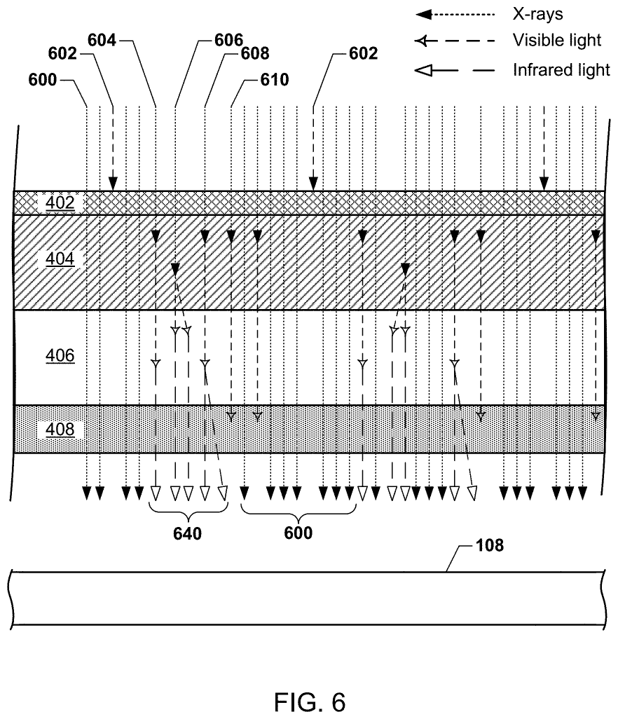

FIG. 6 illustrates some of the photon interactions that may occur within the X ray-to-IR conversion structure 400 when irradiated by X rays 600-610. A majority of incoming X rays 600 will pass directly through the structure 400 without interacting and strike the radiation detector array 108. Any UV or visible light 602 within the scanner system will be blocked by the first layer 402. Some X rays 604 will interact with the second layer 404 material (e.g., Gd₂O₂S) generating UV or visible light that interacts with third layer 406 material (e.g., Nd:YAG) to generate IR photons 604 that pass through the fourth layer 408 to shine on the detector array 108. Some X rays 606 will interact with the second layer 404 material (e.g., Gd₂O₂S) generating multiple UV or visible light photons that each interacts with third layer 406 material (e.g., Nd:YAG) generating respective IR photons 604 that pass through the fourth layer 408 to shine on the detector array 108. Some X rays 608 will interact with the second layer 404 material (e.g., Gd₂O₂S) generating a UV or visible light photon that interacts with third layer 406 material (e.g., Nd:YAG) generating multiple IR photons 604 that pass through the fourth layer 408 to shine on the detector array 108. UV or visible light photons that are not absorbed in the third layer 406 will be prevented from reaching the detector array 108 by the fourth layer 408. Not illustrated is that in some embodiments UV or visible light photons that are not absorbed in the third layer 406 may be reflected back and forth within the structure 400 between the first layer 402 and the fourth layer 408 until absorbed in the generation of one or more IR photons.

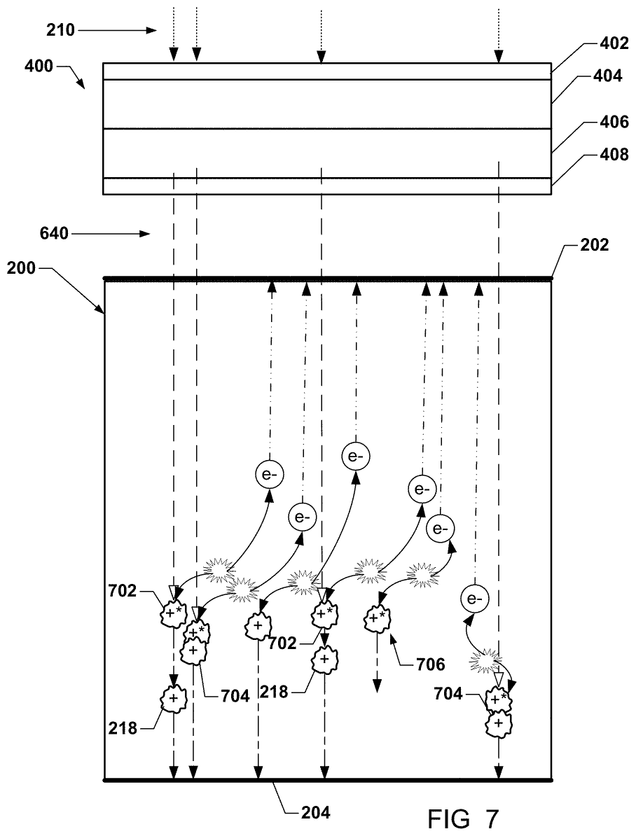

When IR light of 840 nm to 1500 nm wavelength produced by the structure 400 illuminates the CdZnTe crystal of the radiation detector 108, a significant number of electrons and holes are created proportional to the intensity of IR light. These “extra” charge carriers do not contribute to the detector signal. However, depending on the sensor depletion state (negative or positive space charge), these extra charge carriers can recombine with the fixed trapped charges and neutralize them, or fill the traps prior to X ray irradiation. As illustrated in FIG. 7, X rays 210 interacting with the X ray-to-IR converter structure 400 generate IR light that interacts with atoms within the detector 200 to create extra charge carriers that recombine with charges and neutralize fixed trapped charges 704, permitting holes to move to the cathode 204. Also, IR light interactions with atoms within the detector 200 result in heavy holes 702 becoming less massive, and thus more mobile so that the holes move faster to the cathode 204. The flux of IR light need not be strong enough to neutralize all traps, because some traps may remain 706 without resulting in a distortion of the internal electric field sufficient to impact detector accuracy. As a result, the internal electric field will experience less disruption from the buildup of a state charge that would otherwise occur when X ray radiation is started or the intensity varies significantly. As a result, the X ray detection array sensitivity or signal output will be less susceptible to X ray intensity variations, thus reducing dynamic interior electric field distortions due to deep traps and slow hole movement, and improving temporal stability of the detector.

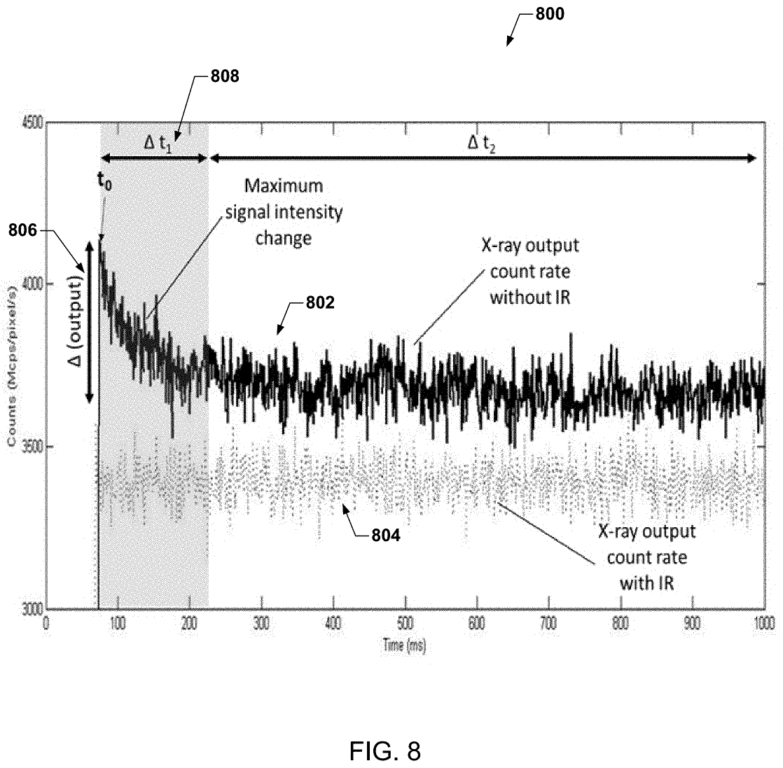

This benefit of various embodiments in terms of stabilizing the output signals of pixels within the X ray detector array can be seen in the graph 800 in FIG. 8. The graph 800 plots the signal output of a single pixel with in a X ray detector array over time spanning one second with and without IR illumination provided by various embodiments.

The solid line 802 shows the output count rate response of a drifting CdZnTe detector pixel under X ray irradiation without exposure to IR light. As can be seen in the graph 800, the count rate when X ray radiation first begins exceeds the count rate at steady-state reached about 100 ms later. The Δ (output) 806 of approximately 500 mega accounts per second highlights the maximum signal distortion under the given irradiation conditions during the time interval AU 808 starting at time t0 when the X ray detector pixel was first exposed to X rays. This signal distortion 806 is the result of the dynamic changes of the interior electric field that occurs until all the traps are filled, reaching a plateau for the time interval Ate. The amount of signal distortion 806 and the time required to reach the plateau 808 are proportional to the type of the trap (life time/residence time), the energy of the trap and the density of the trap. These dynamic time-dependent output changes during signal acquisition (e.g., during a CT scan) can induce artifacts in the reconstructed images. Maintaining a stable output helps to enable accurate scans.

The dotted line 804 represents the output count rate of the X ray detector array pixel for 1 second under the same amount of X ray irradiation while the sensor is being illuminated with IR light. The graph 800 shows the significant improvement in the signal stability, showing that a plateau was reached immediately after the onset of the X rays at time to.

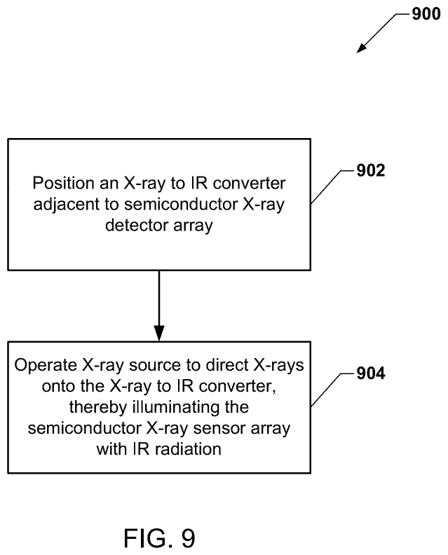

FIG. 9 illustrates a method 900 for implementing various embodiments. The method may include placing an X ray-to-IR converter structure 400 adjacent to a semiconductor X ray detector array 108 in block 902, and then operating the X ray source to direct X rays onto the X ray-to-IR converter structure 400, thereby illuminating the semiconductor X ray detector array in block 904.

The present embodiments may be implemented in systems used for medical imaging, such as in High-Flux applications as in X ray Computed Tomography (CT) for medical applications, and for non-medical imaging applications, such as in baggage security scanning and industrial inspection applications.

Some embodiments include an ionizing radiation to IR converter structure that includes a first layer having a material that is opaque to UV and visible light, a second layer having a material configured to emit UV or visible light upon exposure to ionizing radiation, a third layer comprising a material configured to emit IR light upon exposure to UV or visible light, and a fourth layer comprising a material that is opaque to UV and visible light but transparent to IR light. Some embodiments include an ionizing radiation to IR converter structure that includes a first layer having a material that is opaque to UV and visible light, a second layer having a material configured to emit IR light upon exposure to ionizing radiation, and a fourth layer comprising a material that is opaque to UV and visible light but transparent to IR light. Various embodiments may be configured to be positioned in proximity to a radiation detector array within the imaging system. Various embodiments include imaging systems including an ionizing radiation to IR converter structure configured to illuminate a radiation detector with the IR light when exposed to the ionizing radiation. By exposing the radiation detector to IR light when irradiated, dynamic performance of the radiation detector may be improved, which may reduce defects and improve image quality in X ray or gamma imaging systems.

While the disclosure has been described in terms of specific embodiments, it is evident in view of the foregoing description that numerous alternatives, modifications and variations will be apparent to those skilled in the art. Each of the embodiments described herein may be implemented individually or in combination with any other embodiment unless expressly stated otherwise or clearly incompatible. Accordingly, the disclosure is intended to encompass all such alternatives, modifications and variations which fall within the scope and spirit of the disclosure and the following claims.

What is claimed is:

1. A structure for use in an imaging system, comprising:
a first layer comprising a material that is opaque to ultraviolet (UV) and visible light;
a second layer comprising a material configured to emit UV or visible light upon exposure to ionizing radiation;
a third layer comprising a material configured to emit infrared (IR) light upon exposure to UV or visible light; and
a fourth layer comprising a material that is opaque to ultraviolet (UV) and visible light but transparent to IR light.

2. A structure for use in imaging systems, comprising:
a first layer comprising a material that is opaque to ultraviolet (UV) and visible light;
a second layer comprising a material configured to emit infrared (IR) light upon exposure to ionizing radiation; and
a third layer comprising a material that is opaque to ultraviolet (UV) and visible light but transparent to IR light.

3. The structure claim 1, wherein the structure is configured to be positioned in proximity to a radiation detector array within the imaging system.

4. The structure of claim 1, wherein the first layer is aluminum or an aluminum alloy.

5. The structure of claim 1, wherein the second layer comprises a material selected from the group anthracene (C₁₄H₁₀), stilbene (C₁₄H₁₂), naphthalene (C₁₀H₈), p-terphenyl (C₁₈H₁₄), PBD (C₂₀H₁₄N₂O), butyl PBD (C₂₄H₂₂N₂O), PPO (C₁₅H₁₁NO), POPOP (C₂₄H₁₆N₂O), polyethylene naphthalate (C₁₄H₁₀O₄)ₙ), polyphenyl hydrocarbons, oxazole and oxadiazole aryls, n-terphenyl (PPP), 2,5-diphenyloxazole (PPO), 1,4-di-(5-phenyl-2-oxazolyl)-benzene (POPOP), 2-phenyl-5-(4-biphenylyl)-1,3,4-oxadiazole (PBD), tert-butylphenyl)-5-(4″-biphenylyl)-1,3,4-oxadiazole (B-PBD), as Gd₂O₂S:Tb, thallium-doped sodium iodide (NaI(Tl)), CsI(Tl), CsI(Na), CsI(pure), CsF, KI(Tl), LiI(Eu), CsI(Tl), CsI(Na), CsI(pure), CsF, KI(Tl), LiI(Eu), BaF₂, CaF₂(Eu), ZnS(Ag), CaWO₄, CdWO₄, YAG(Ce) (Y₃Al₅O₁₂(Ce)), GSO, LSO, LaCl₃(Ce), lanthanum chloride doped with cerium, cerium-doped lanthanum bromide (LaBr₃(Ce)), LYSO (Lu_{1.8}Y_{0.2}SiO₅(Ce)), or cerium-activated lithium or boron silicates.

6. The structure of claim 1, wherein the second layer comprises a Gd₂O₂S:Tb crystal.

7. The structure of claim 1, wherein the third layer comprises a material selected from the group of neodymium-doped glass, ytterbium-doped glass, holmium-doped glass, thulium-doped glass, erbium-doped glass, or Ca₁₄Zn₆Al₁₀O₃₅: Mn⁴⁺, Nd³⁺/Yb³⁺.

8. The structure of claim 1, wherein the third layer comprises neodymium doped yttrium aluminum garnet (Nd:YAG).

9. The structure of claim 1, wherein the fourth layer comprises a CdZnTe crystal or sapphire.

10. The structure of claim 2, wherein the third layer comprises a CdZnTe crystal or sapphire.

11. The structure of claim 1, wherein an interior surface of the first layer is configured to reflect UV and visible light.

12. The structure of claim 1, wherein an interior surface of the fourth layer is configured to reflect UV and visible light.

13. The structure of claim 2, wherein an interior surface of the third layer is configured to reflect UV and visible light.

14. The structure of claim 1, wherein the ionizing radiation is X ray radiation or gamma radiation.

15. An imaging system, comprising:
a source of ionizing radiation;
a radiation detector; and
a structure positioned adjacent to the radiation detector and configured to emit infrared radiation when exposed to the ionizing radiation.

16. The imaging system of claim 15, wherein the structure comprises:
a first layer comprising a material that is opaque to ultraviolet (UV) and visible light;
a second layer comprising a material configured to emit UV or visible light upon exposure to ionizing radiation;
a third layer comprising a material configured to emit infrared (IR) light upon exposure to UV or visible light; and
a fourth layer comprising a material that is opaque to ultraviolet (UV) and visible light but transparent to IR light.

17. The imaging system of claim 16, wherein the source of ionizing radiation comprises an X-ray source configured to emit the ionizing radiation which comprises X ray radiation.

18. The imaging system of claim 16, wherein the ionizing radiation is gamma radiation.

19. A method of imaging an object using ionizing radiation, comprising:
providing a radiation detector and a structure configured to emit infrared radiation when exposed to ionizing radiation located adjacent to the radiation detector; and
exposing the object to ionizing radiation so that the ionizing radiation passes through the object, through the structure and into the radiation detector.

20. The method of claim 19, wherein:
the structure emits infrared radiation upon exposure to the ionizing radiation;
the infrared radiation and the ionizing radiation are provided into the radiation detector; and
the ionizing radiation comprises X ray or gamma radiation.
